(19) United States
(12) Patent Application Publication
(10) Pub. No.: US 2011/0141535 A1
(43) Pub. Date: Jun. 16, 2011

(54) DOCUMENT SCANNER WITH AUTOMATIC DUST AVOIDANCE

(76) Inventors: Robert M. Westcott, Holley, NY (US); Jude A. SanGregory, Spencerport, NY (US)

(21) Appl. No.: 12/636,867

(22) Filed: Dec. 14, 2009

(51) Int. Cl. H04N 1/46; H04N 1/04

(52) U.S. Cl. 358/505; 358/498

(57) ABSTRACT

A document scanner with automatic dust avoidance includes an automated document feeder; a transparent plate; an illumination source for illuminating the document through the transparent plate; at least one mirror for reflecting light reflected from the document; at least one sensor for imaging light from the at least one mirror; a microprocessor for determining the presence of dust on the transparent plate; and a motor for tilting the at least one mirror when dust is detected on the transparent plate.

### FIELD OF THE INVENTION

The invention concerns improvements to a document scanner to eliminate image artifacts caused by the collection of dust or damage in the optical path. More particularly, the invention concerns such scanners in which documents are automatically fed past one or more stationary imagers comprising a sensor, lens, and mirrors.

### BACKGROUND OF THE INVENTION

Sheet fed scanners have become a popular computing accessory both in the home and the office. With respect to sheet fed scanners, an image forming subsystem, such as a camera, typically a charged couple device (CCD) and a lens in combination with an illumination source, sits in a stationary position and scans an image as a sheet of paper is moved past the camera, through a narrow transport path, by a paper transport mechanism. Individual raster lines are imaged by the camera and then pieced together to create a two-dimensional (2D) image representation of the original document. The camera is basically imaging one sliver of the document many times as the document is moved past the camera. The paper motion supplies one dimension of the document image, while the width is supplied by the camera. The in-paper travel direction and the width of the document are determined by the optics magnification and the dimensions of the CCD within the image forming subsystem.

In some cases, the shape of the sheet fed scanners paper path is semi-circular. For example, some scanners have a semi-circular paper path wherein sheets can be fed from a tray on top and exit beneath, or vice versa. In other cases, the paper path is “straight through.” In some cases, the scanner has two cameras, one for imaging the front side of the sheet or document, the other for imaging the rear side of the sheet or document.

A portion of the transport path is made of a transparent material, such as glass or plastic, so that an illumination source can illuminate the documents and so that the cameras can capture images of the documents. Dust can build up on the transparent surface, which can cause artifacts in the captured image of the document. For example, as the document is moved past the transparent surface, if there is a dust particle on the transparent surface, it may be imaged by the CCD. If the dust particle remains on the transparent surface for the full duration of scanning a document, the captured image will have a streak in the image at the location of the dust particle.

U.S. Pat. No. 7,058,236 describes an attempt to solve this problem by moving the illumination system and one or more camera mirrors behind the transparent plate. If dust is detected, the illumination and mirrors are repositioned behind the transparent plate to avoid imaging the document through the dust. A disadvantage of this method is that it requires relatively large motors and complex linear slide mechanisms to independently move these components. Also, power cables for the illumination must be made flexible and carefully routed to prevent damage from repeated movement.

In another prior art example, the camera is comprised of a contact image sensor (CIS) that is movable behind the transparent surface. If dust is detected, the CIS is repositioned behind the transparent plate to avoid imaging the document through the dust. A disadvantage of this method is that the CIS includes the sensor and its circuit board as well as the entire illumination system. This requires relatively large motors and a complex linear slide mechanism to move these components. Also, power and data wires for the sensor and illumination must be made flexible and carefully routed to prevent damage from repeated movement.

A simple and inexpensive dust avoidance mechanism is desired that works in a scanner having stationary imagers comprising a sensor, lens and mirrors.

### SUMMARY OF THE INVENTION

Briefly, according to one aspect of the present invention a document scanner with automatic dust avoidance includes an automated document feeder; a transparent plate; an illumination source for illuminating the document through the transparent plate; at least one mirror for reflecting light reflected from the document; at least one sensor for imaging light from the at least one mirror; a microprocessor for determining the presence of dust on the transparent plate; and a motor for tilting the at least one mirror when dust is detected on the transparent plate.

The invention and its objects and advantages will become more apparent in the detailed description of the preferred embodiment presented below.

### BRIEF DESCRIPTION OF THE DRAWINGS

For a better understanding of the invention, reference is made to the following detailed description taken in conjunction with the appended drawings in which:

FIG. 1 is a perspective view of a sheet fed scanner according to the prior art;

FIG. 2 is a side sectional view of a sheet fed scanner illustrating the paper path, illumination source, camera location, input and output trays according to the prior art;

FIG. 3 is a detailed view of a sheet fed scanner paper path and sheet drive means according to the prior art;

FIG. 4 is a detailed view of the auto feeder portion of a sheet fed scanner paper transport according to the prior art;

FIGS. 5-7 are the upper paper path portion of the sheet fed scanner with a view of the upper camera attached according to the prior art;

FIG. 8 is a schematic view of the optical fold and major elements of the upper camera, illumination source and paper path of a prior art sheet fed scanner;

FIG. 9 is a schematic view of the optical fold and major elements of the upper camera, illumination source and paper path of the preferred embodiment of the invention;

FIG. 10 is a schematic view of the optical fold and major elements of the upper camera, illumination source and paper path of the preferred embodiment of the invention with a particle of dust on the transparent plate in a location where it will be imaged by the camera;

FIG. 11 is a schematic view of the optical fold and major elements of the upper camera, illumination source and paper path of the preferred embodiment of the invention when the pivoting mirror is rotated to redirect the optical fold away from a particle of dust;

FIG. 12 is a perspective view of the optical fold and major elements of the upper camera, illumination source and paper path of the preferred embodiment of the invention with the camera housing not shown;

FIG. 13 is a perspective view of the optical fold and major elements of the upper camera, illumination source and paper path of the preferred embodiment of the invention with the camera housing shown;

FIG. 14 is a block diagram showing an arrangement of a control system according to the present invention;

FIG. 15 is a schematic view of the mirror pivot motor, gears and cam according to the present invention;

FIG. 16 is a graph showing scan position as a function of cam angle for the preferred embodiment—cam and yoke relationships are shown at various positions for clarity;

FIG. 17 is a perspective view of the optical fold and major elements of the upper camera, illumination source and paper path of the preferred embodiment of the invention showing the optical folded path imaging a calibration patch;

FIG. 18 is a schematic view showing three scan positions through a glass window having a calibration patch with angled edge; and

Corresponding numerals and references in the detailed description correspond to like parts in the figures unless otherwise indicated.

### DETAILED DESCRIPTION OF THE INVENTION

The invention has been described in detail with particular reference to certain preferred embodiments thereof, but it will be understood that variations and modifications can be effected within the scope of the invention.

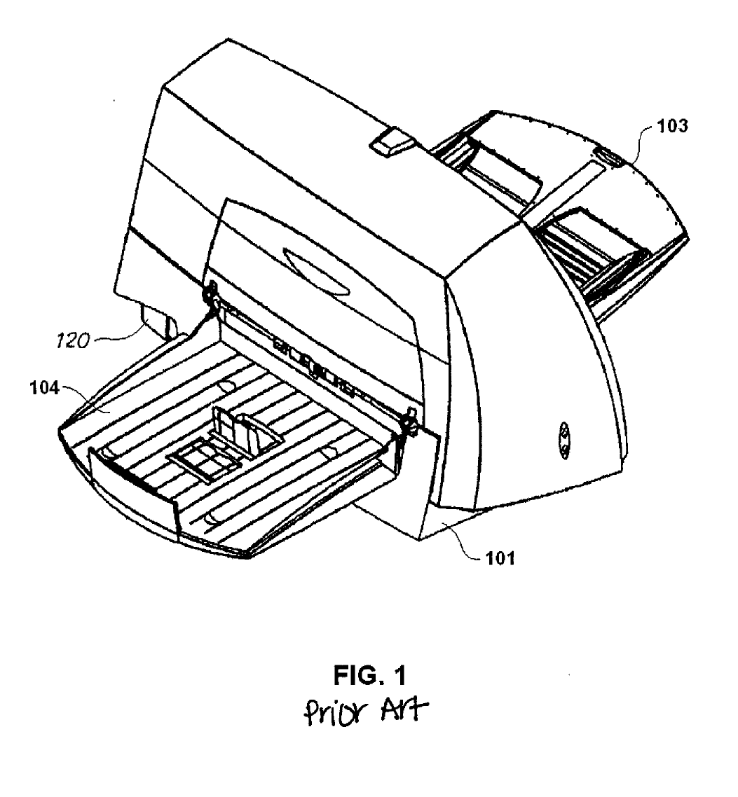

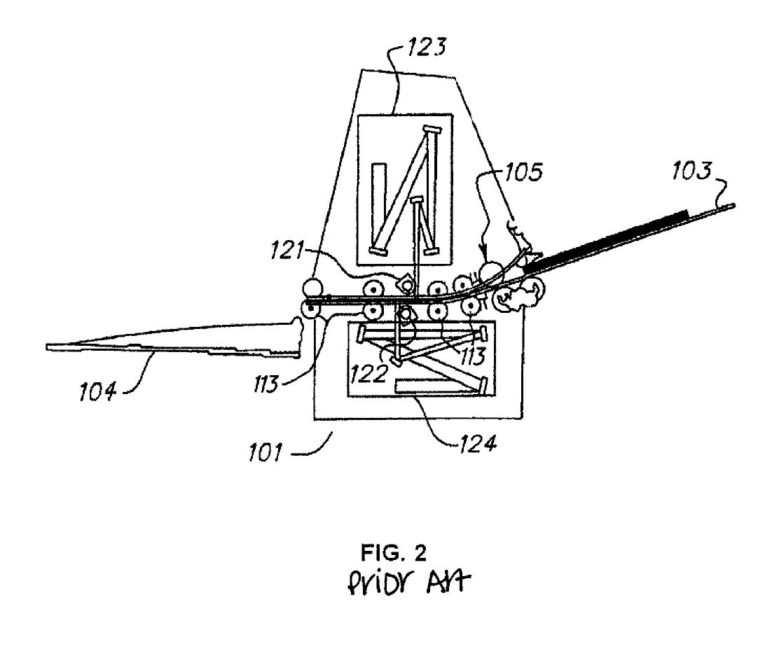

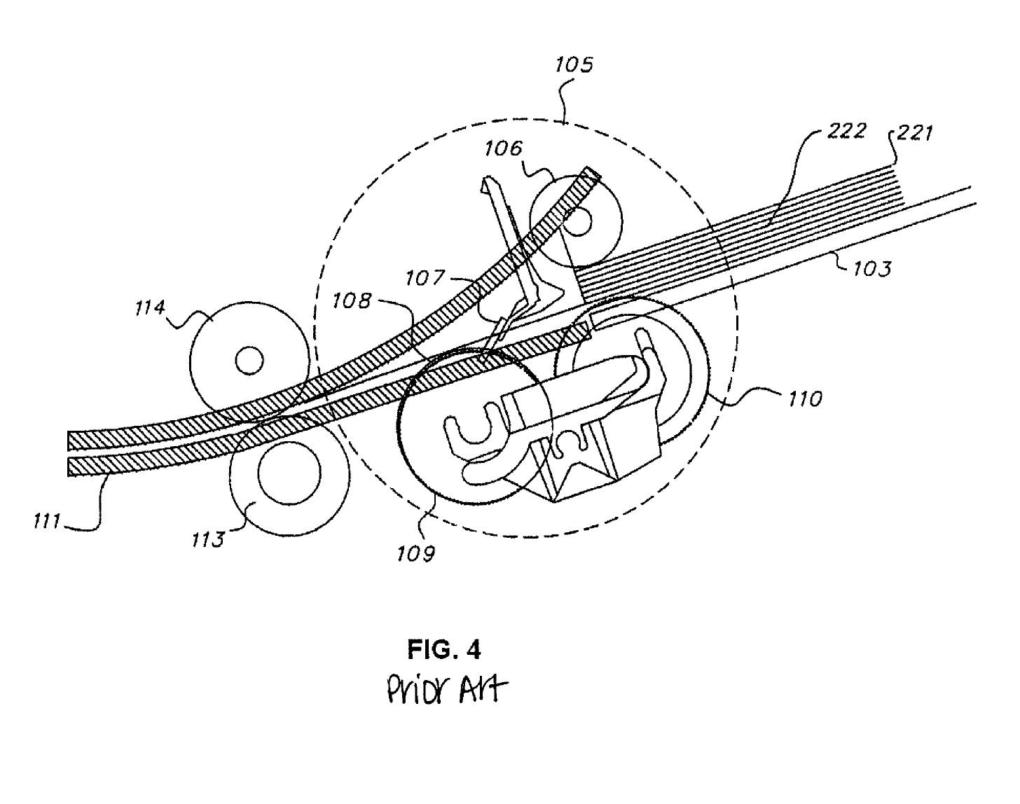

In one embodiment a modular scanner according to the present invention comprises a sheet fed scanning unit. As shown in FIGS. 1-4, in the sheet fed transport scanning unit 101, sheets 221 are fed into a paper path with the use of an auto feeder mechanism 105. The auto feeder consists of a stack support or input tray 103, an urging or picker roller 110, a pressure roller 106, a feed roller 109, a pre-separation pad 107, and a separation roller 108. When commanded to feed, the scanner's auto feeder 105 advances sheets 221 from a stack 222 placed on the stack support 103 into the scanners paper path. The functions of the urging or picker roller 110, separation roller 108, and pre-separation pad 107 are commonly found within the art of friction feeding devices as they serve to singularly advance the intended sheet to be imaged into the transport and hold back or retard any subsequent non-intended sheets. The stack support 103 can be referred to as an entrance, supply, or input tray. A side view of the auto feeder 105 is shown in FIG. 4.

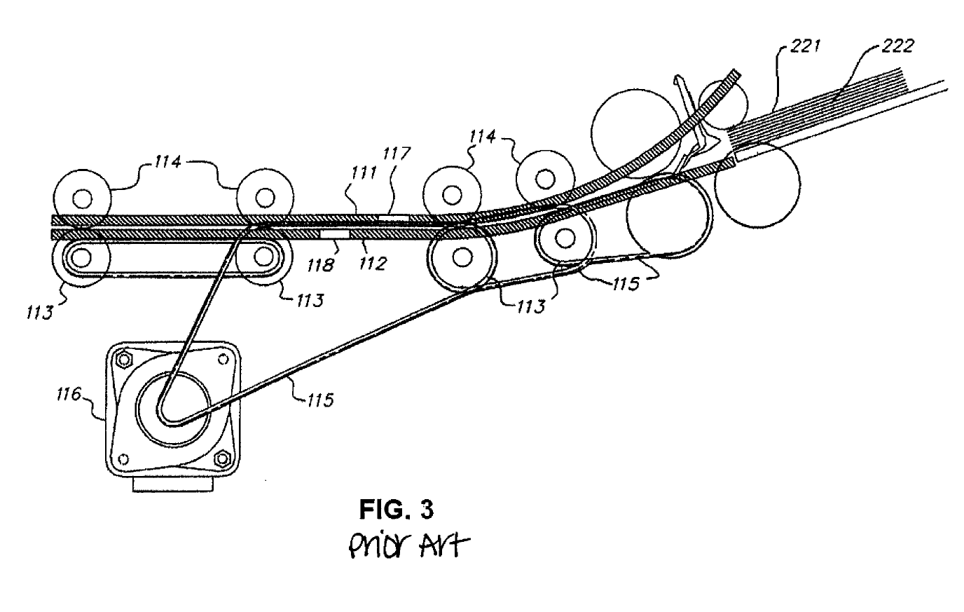

The paper path consists of an upper and lower portion 111, 112. The lower paper path portion 112 contains drive rollers 113 which move the sheets 221. The upper paper path portion 111 housing idler or normal force rollers 114 provide the necessary contact forces for the drive rollers. The drive rollers 113 are in turn driven through a series of timing belts 115 which are connected through a pulley arrangement to a drive motor 116, shown in FIG. 3.

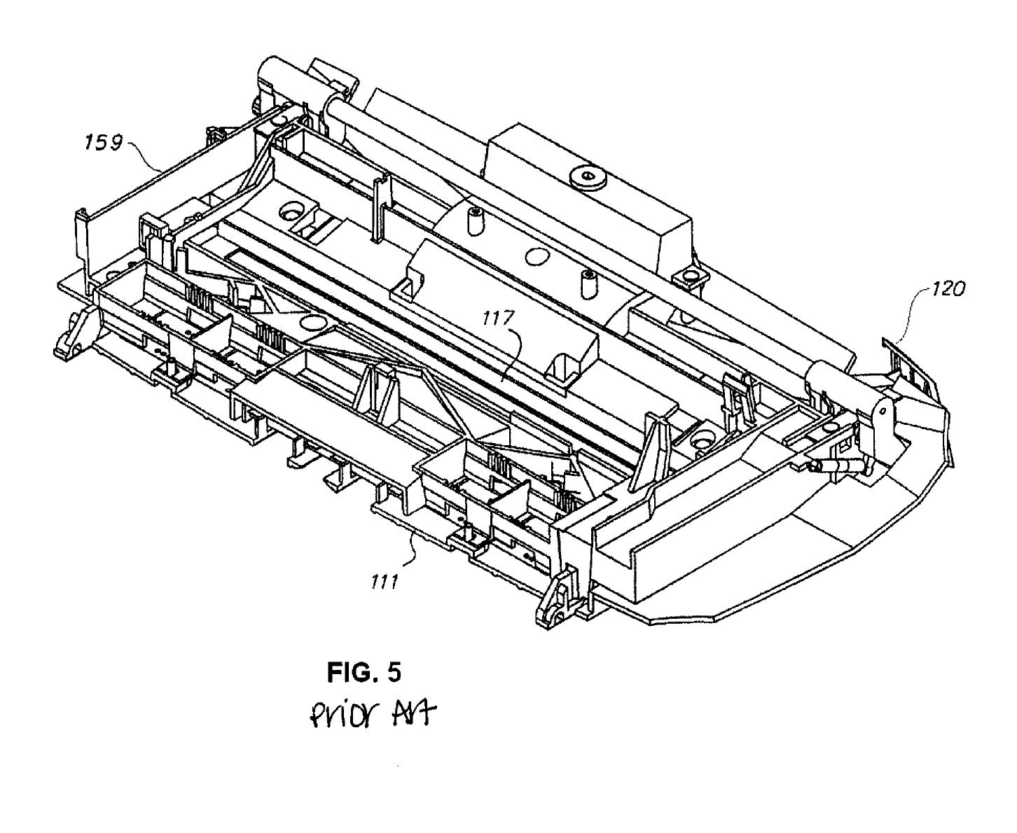

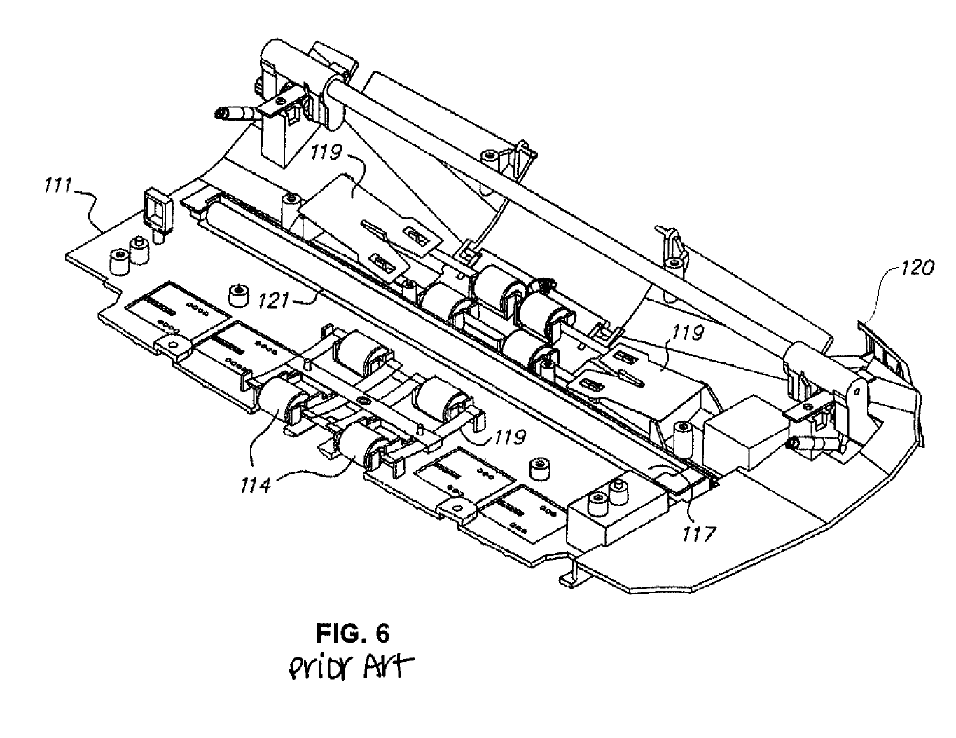

The upper and lower paper paths 111 and 112 are also constructed with an upper and lower clear aperture area or glass window 117 and 118. The upper paper path consists of a substantially flat paper path portion and a structural supporting frame 159 that is screwed to the path. This upper path is pivotably mounted to the lower paper path and in turn, the lower paper path is attached to a base structure. The upper path normal force rollers 114 are aligned and in contact with the lower paper path drive rollers 113 thereby forming a nip line through which drive is imparted to the sheets 221. The upper paper path rollers 114 are idlers that are spring loaded against the drive rollers 113 when the upper paper path is pivoted down and secured by the latching mechanism 120, as shown in FIGS. 5 and 6.

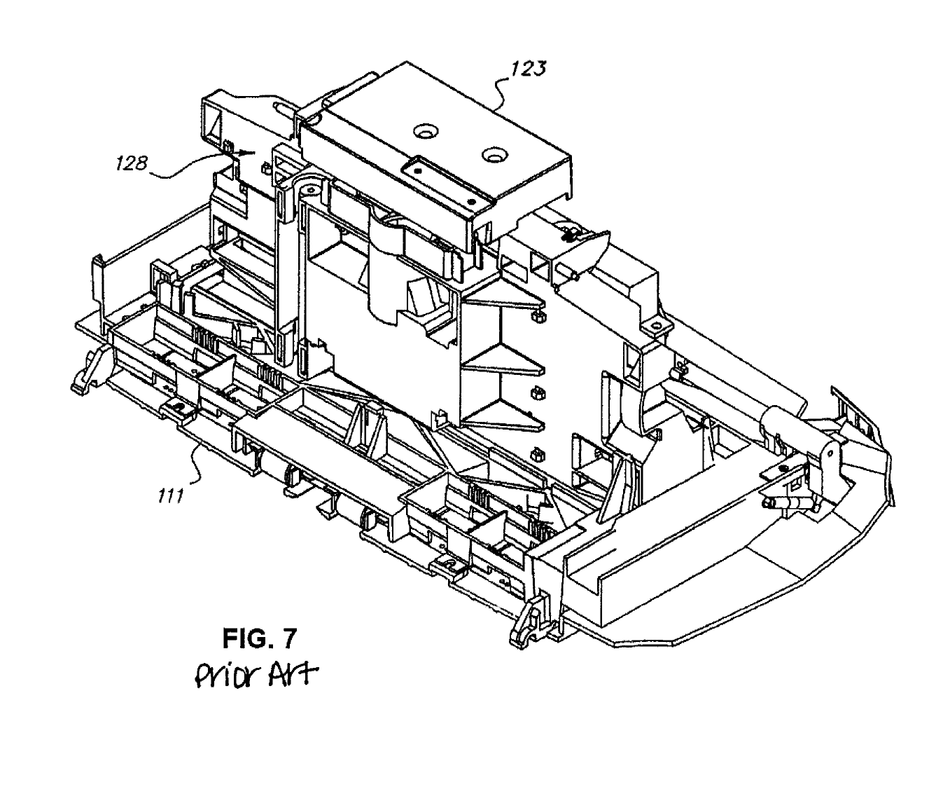

Mounted to the upper paper path 111 are an upper illumination source (lamp) 121 and an upper camera 123, shown in FIGS. 6-8. As sheets 221 are moved through the paper path, an image of the top side of the sheet is formed by reflected light from the lamp off the sheet. The reflected light then bounces off a series of fold mirrors 127 and through a lens 126 where it is focused onto a charged coupled device (CCD) imager 125. The camera housing 128 hat holds the mirrors 127, lens 126, CCD 125, and CCD circuit board that make up the upper camera. The CCD width or (number of pixels) makes up one dimension of the image and the paper travel and successive lines of CCD output form the other dimension of the two-dimensional image. This method of creating images is universally applied by scanners of the sheet fed variety where the illumination and camera are held stationary and the paper is moved past them. These images are then output from the scanner to a connected computer where they are either stored or manipulated for customer use. In the present invention, the illumination source is a pair of light emitting diode (LED) arrays but this approach could be accomplished by any suitable light source such Xenon gas fluorescent lamps, Hg fluorescent, and halogen. In the present invention the CCD/lens reduction camera is of a four channel design (red, green, blue, and black) but could also be of a single channel design or any other desired makeup. In the making of a color imager, one could use a single channel CCD and then alternate their illumination source to be of red, green, and then blue light as an alternative to a multi-channel CCD with a “white” light source. The CCD/lens reduction camera (imager) could also be replaced with a contact array or other such imaging device.

In the same manner as described for the upper camera, the lower camera 124 produces images of the bottom side of the sheets being fed as they pass over the lower paper path clear aperture. Also mounted to the base unit is a sheet support that receives sheets as they exit the paper path. This support is commonly referred to as an exit or output tray 104 as shown in FIG. 1.

To summarize, the sheet fed scanning for a single sheet, the process begins with a command to feed, the sheet passes the clear apertures and is imaged on both top and bottom sides and then it is deposited in the output tray. For a stack of documents, this process is repeated until the stack is depleted.

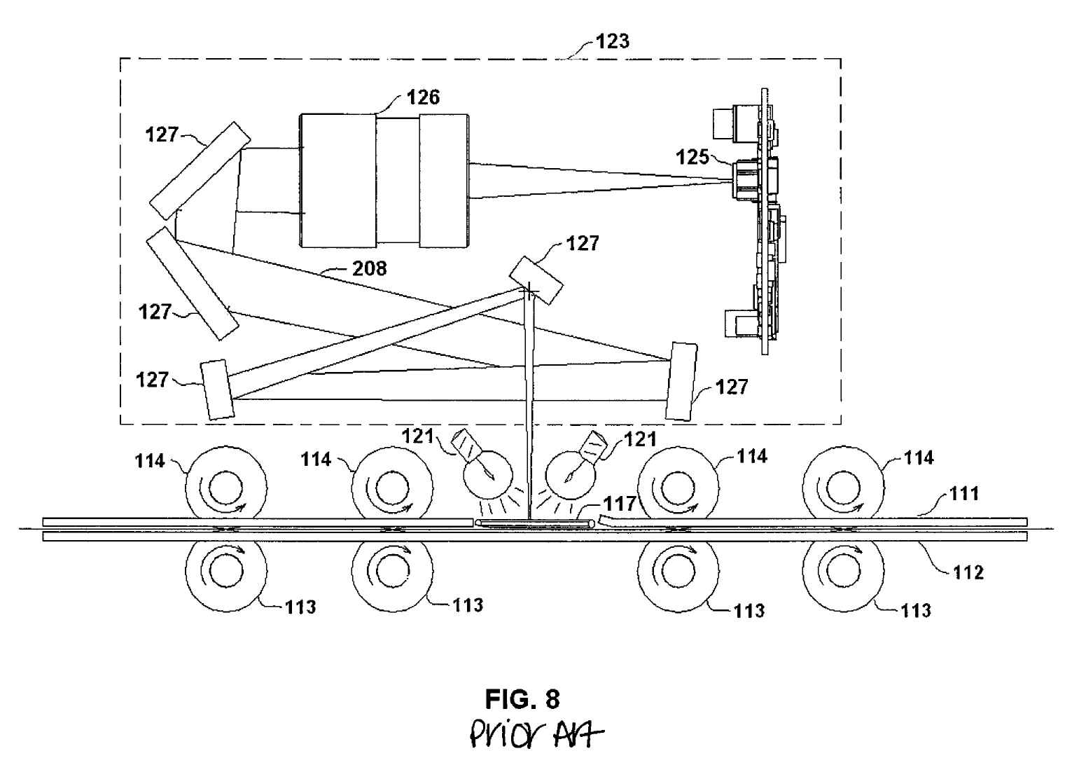

A sheet fed scanner having a camera of the type having one or more stationary imagers comprising a sensor, lens, and mirrors is shown in FIG. 8. An upper camera 123 is comprised of a CCD imager 125, a lens 126 and one or more stationary mirrors 127. The lens 126 is used to focus an image of a narrow portion of document 221 onto CCD 125 as the document 221 is fed past glass window 117, between upper paper path 111 and lower paper path 112, and illuminated by illumination sources 121, 122. The focused beam is reflected off of five mirrors to create an optical folded path 208 between the document 221 and CCD 125. This allows the camera to be more compact than if no mirrors were used.

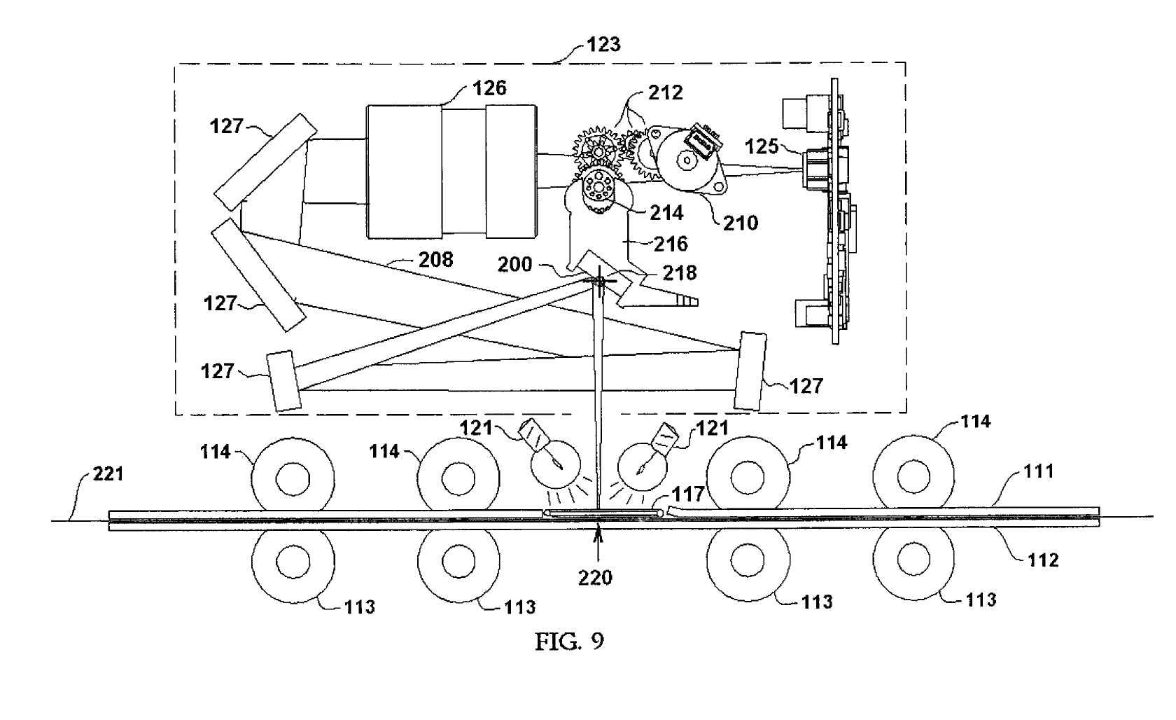

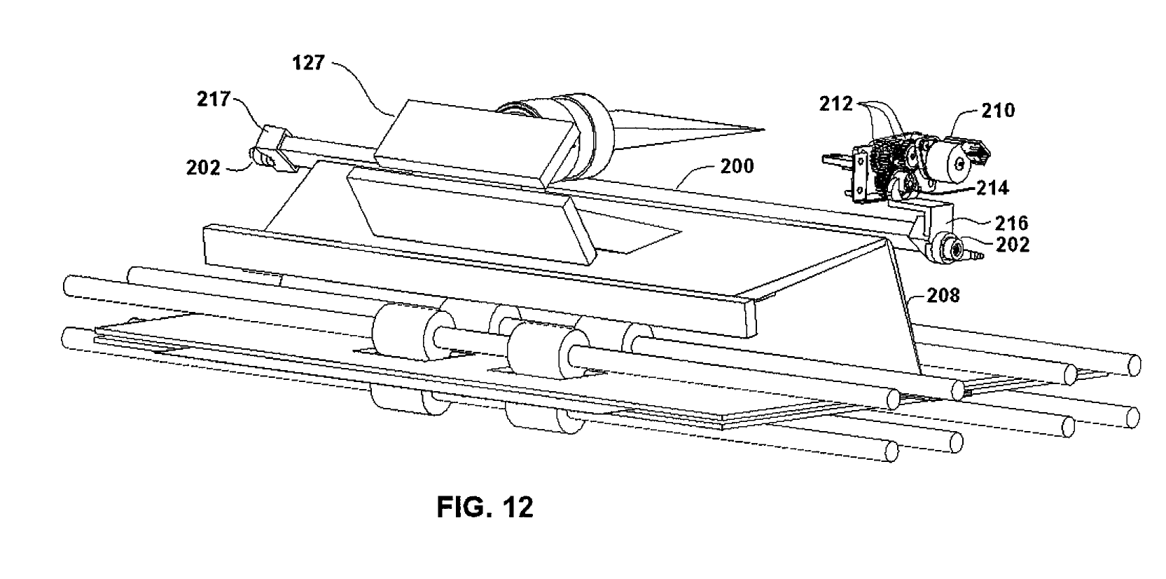

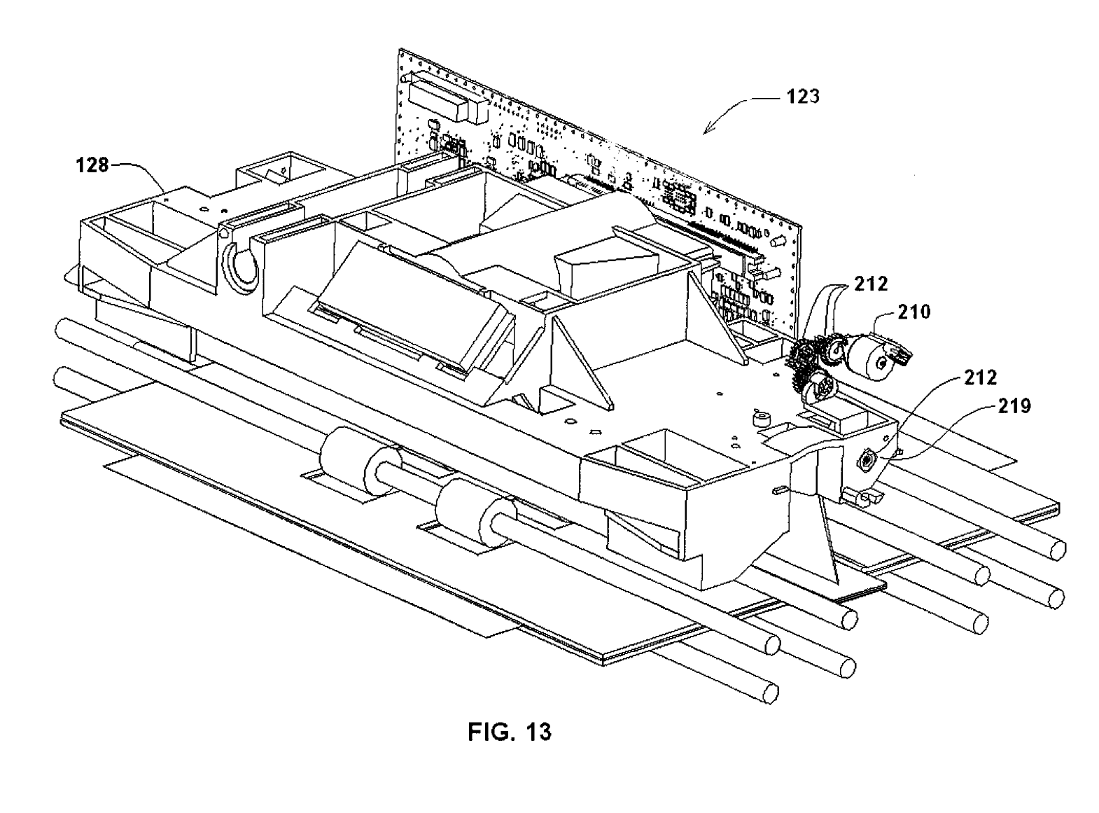

FIGS. 9-13 show the preferred embodiment of the invention, in which the camera has been adapted for streak removal. In the invention, the first mirror in the optical folded path is not fixed. In FIGS. 9, 12, and 13 pivoting mirror 200 is mounted to yoke 216 and end cap 217. Mirror pivot bearings 202 are also attached to yoke 216 and end cap 217 and rotate about pivot axis 218, formed by two bearing holes 219 in camera housing 128. Cam 214 is rotated by pivot motor 210, through gear train 212. Yoke 216 acts as a cam follower and is rotated about pivot axis 218 as cam 214 rotates. Cam 214, gears 212, and pivot motor 210 are mounted to components that are not shown in the figures for clarity. In FIG. 9, pivoting mirror 200 is tilted to the point in the middle of its full range, causing folded optical path 208 to intersect glass window 117 at a central scan position 220.

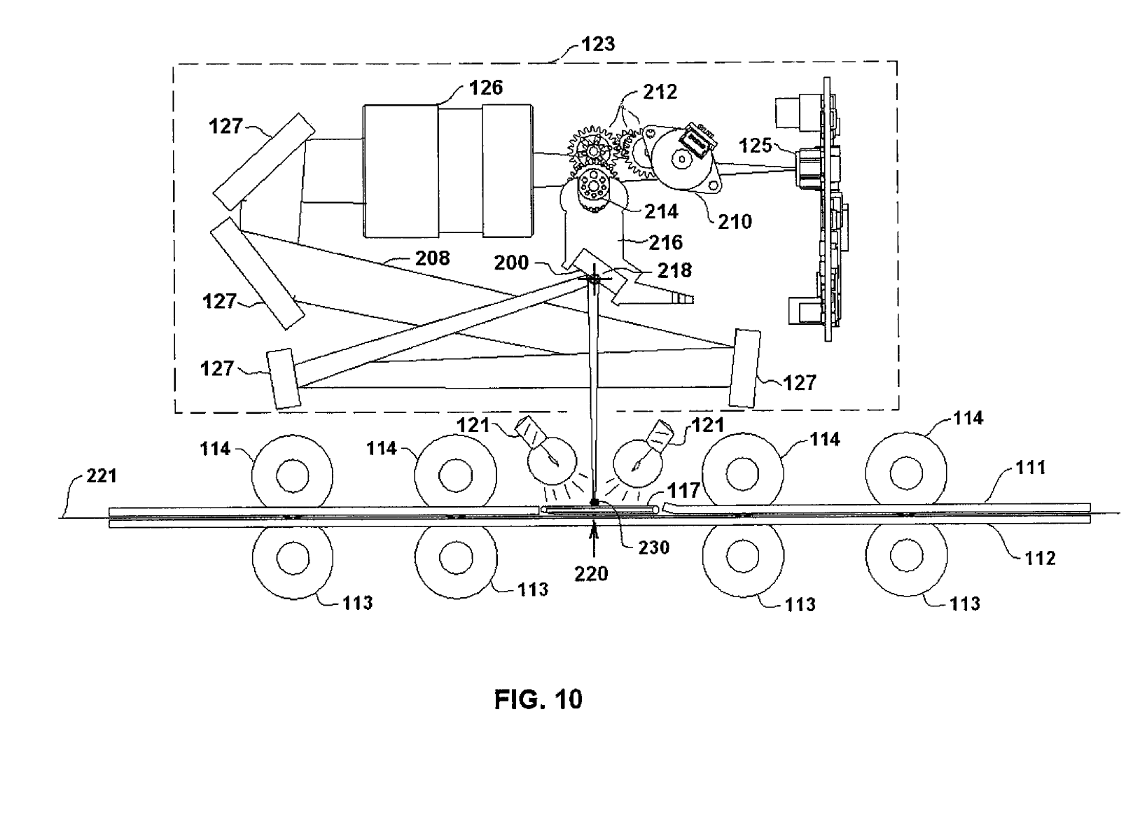

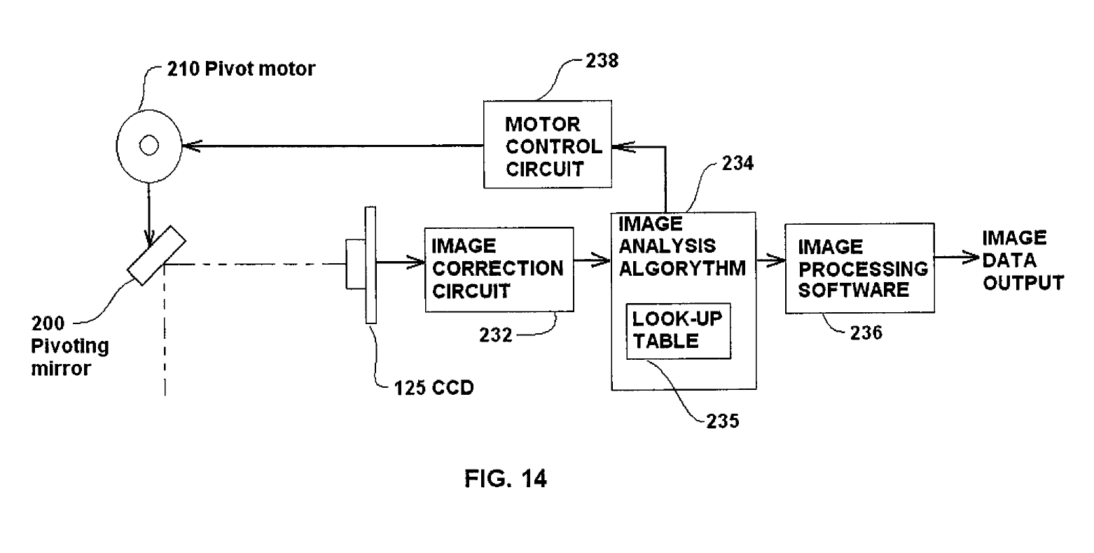

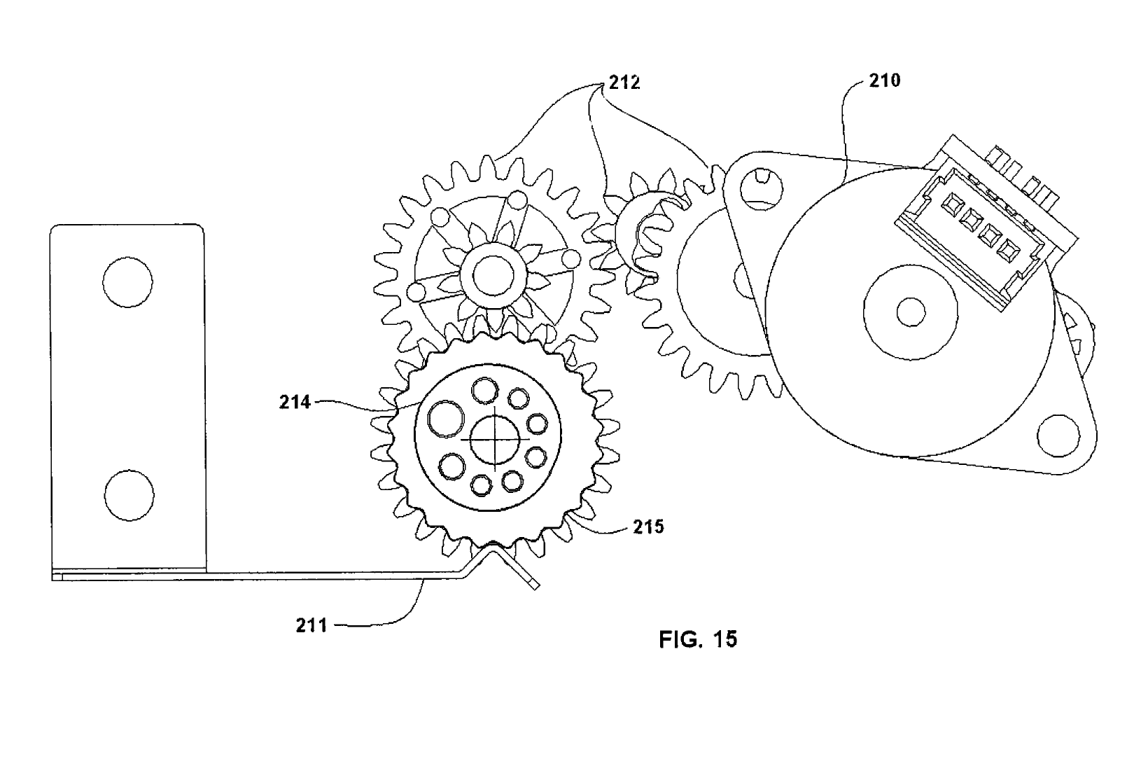

If, as shown in FIG. 10, a dust particle 230 becomes stuck on glass window 117 and coincident with folded optical path 208, a streak will be formed on the CCD image of the document at a position coincident with the dust particle. As shown in FIG. 14, raw camera data is sent to image correction circuit 232. Corrected image data is sent to an image analysis algorithm 234 and then to image processing software 236. After being processed, the final image data output can be stored or sent to another device such as a connected computer. If image analysis algorithm 234 detects a streak in the corrected image data, it predicts a new dust free scan position. This new position may be arbitrary or may be determined by analyzing previous scans. For example, positions may be avoided if streaks were found previously at those positions. Before the next document is scanned, motor control circuit 238 causes pivot motor 210 to drive pivoting mirror 200 to a new scan position. The goal is to find a dust free scan position. Subsequent document scans are subjected to the same process, and mirror corrections are made until a dust free scan position is determined.

The process of determining a dust free scan position is iterative. During this process, scanned images may contain streaks caused by dust. Image processing software 236 may include algorithms to remove these streaks by interpolation or pixel replacement. To minimize the number of iterative steps, the image analysis algorithm 234 specifies mirror corrections that move the scan position a distance larger than an average dust particle.

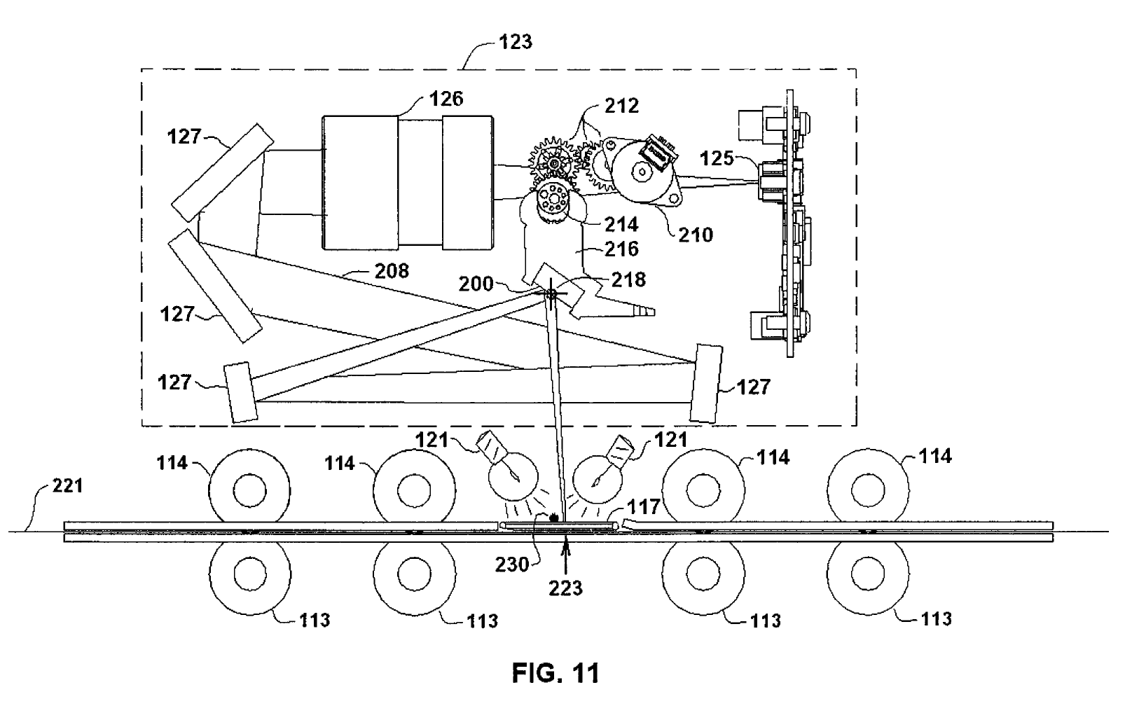

In FIG. 11, pivot motor 210 has rotated cam 214 to rotate yoke 216 and tilt pivoting mirror 200 to alter folded optical path 208 to be directed to dust-free scan position 223. Cam 214 is configured to provide equal mirror angular changes for given cam angle changes. Also, cam 214 includes a plurality of detent notches 215 that are engaged by detent pawl 211 to lock cam 214 into discrete angular positions. These positions correspond to scan positions that are separated by a distance of approximately two times the size of an average dust particle. Thus when dust is detected the mirror is pivoted to yield a new scan position that is unlikely to have a streak caused by the same piece of dust.

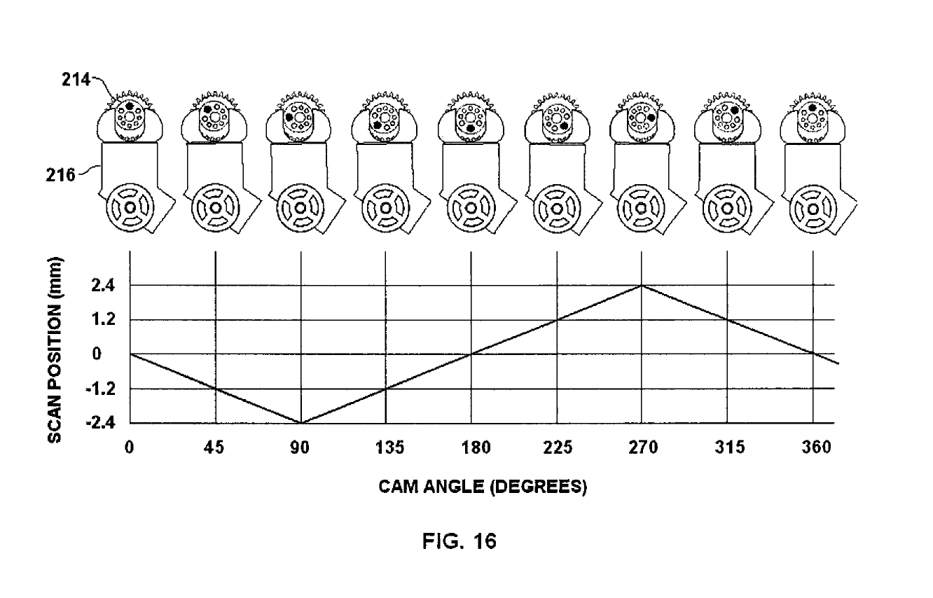

FIG. 16 shows how scan position varies with cam angle in the preferred embodiment that has a scan position range equal to 4.8 mm. When at zero degrees, the cam positions the yoke at an angle such the scan position is at its nominal or zero mm. If the cam is rotated counter-clockwise by 90 degrees, the scan position is moved to the extreme negative value of −2.4 mm. Cam angles of 45 degrees and 135 degrees result in the same scan position of −1.2 mm. Cam angles of 0 degrees and 180 degrees result in the same central (0 degree) scan position. As the cam revolves between 180 degrees and 360 degrees, the scan position ranges from 0 mm to +2.4 mm.

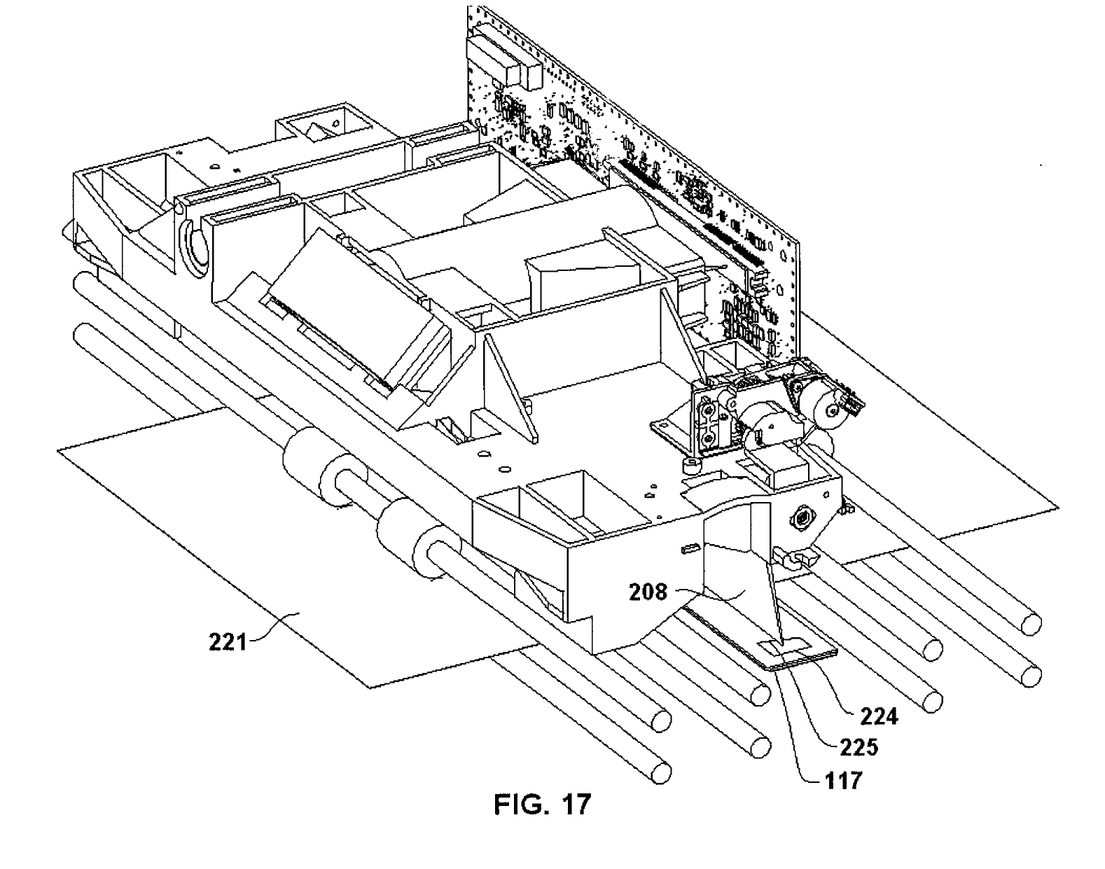

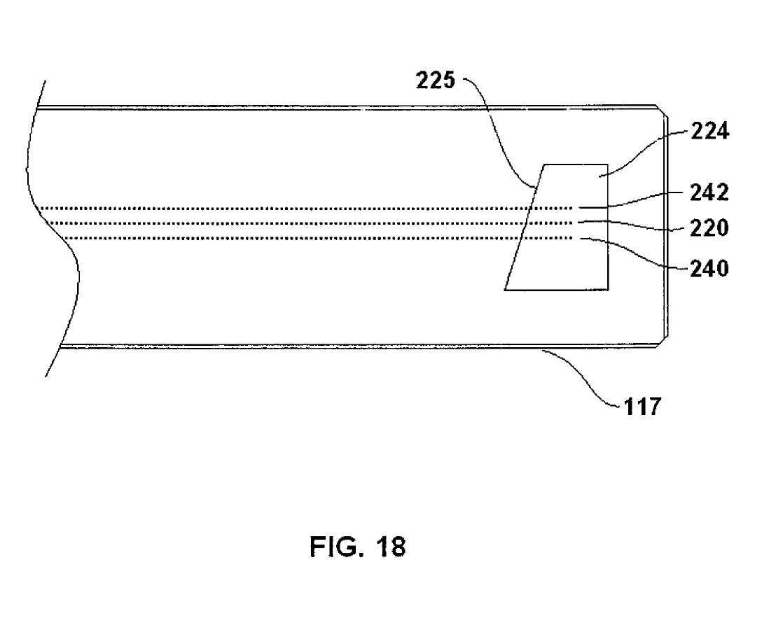

Because the illumination source 121 remains stationary, there is a change in illumination intensity of the document being scanned as scan position is changed. Scan positions further from the illumination focus point will have lower illumination intensity. FIGS. 17-18, a calibration patch 224, having angled edge 225, is printed onto glass window 117 at a location beyond where documents are typically scanned. As shown in FIG. 18, at maximum lower scan position 240, more CCD pixels image the white patch than at maximum upper scan position 242. Image analysis algorithm 234 counts the number if CCD pixels that image the white patch 224 at both the maximum lower scan position 240 and maximum upper scan position 242. The central scan position 220 is then determined by image analysis algorithm 234 as the point midway between positions 240 and 242. After image analysis algorithm 234 determines the central scan position 220, a look-up table 235 is created in image analysis algorithm 234 that maps illumination intensity to scan position. Therefore, gains can be applied to the image data to correct for changes in illumination intensity as a result of changes in scan position.

During normal operation, the scanner starts scanning at central scan position 220. This position provides the most illumination. If a dust particle is detected the mirror is pivoted to yield a new scan position that is unlikely to have a streak caused by the same piece of dust. A gain is applied to the image data by image processing software 236, based upon the look-up table 235, to correct for illumination intensity changes at the new scan position.

The invention has been described in detail with particular reference to certain preferred embodiments thereof, but it will be understood that variations and modifications can be effected within the scope of the invention.

### PARTS LIST

101 sheet fed transport scanning unit
103 stack support (input tray)
104 output tray (exit hopper)
105 auto feeder mechanism
   106 pressure roller
107 pre-separation pad
108 separation roller
109 feed roller
110 urging (picker) roller
111 paper path (upper)
112 paper path (lower)
113 drive rollers
114 idler (normal force) rollers
115 timing belts (sheet fed transport)
116 drive motor (sheet fed transport)
117 glass window (clear aperture) upper camera
118 glass window (clear aperture) lower camera
119 idler (normal force) roller springs
120 latching mechanism
121 illumination source (LED) upper
122 illumination source (LED) lower
123 upper camera
124 lower camera
125 CCD imager
126 lens
127 fixed fold mirrors
128 camera housing
159 structural supporting frame
200 pivoting mirror
202 mirror pivot bearings
208 folded optical path
210 pivot motor (mirror)
211 detent pawl
212 gear train (mirror)
214 cam
215 detent notches (cam gear)
216 yoke (mirror pivot)
217 end cap (mirror pivot)
218 pivot axis (mirror)
219 bearing holes
220 central scan position
221 sheet (document)
222 stack (documents)
223 dust-free scan position
224 calibration patch
225 angled edge
230 dust particle
232 image correction circuit
234 image analysis algorithm
235 look-up table
236 image processing software
238 motor control circuit
240 maximum lower scan position
242 maximum upper scan position

1. A document scanner with automatic dust avoidance comprising:
an automated document feeder;
a transparent plate;
an illumination source for illuminating the document through the transparent plate;
at least one mirror for reflecting light reflected from the document;
at least one sensor for imaging light from the at least one mirror;
a microprocessor for determining the presence of dust on the transparent plate; and
a motor for tilting the at least one mirror when dust is detected on the transparent plate.

2. The apparatus of claim 1 wherein said at least one sensor is comprised of a linear array of sensors.

3. The apparatus of claim 1 wherein said at least one sensor is comprised of a plurality of linear sensor arrays.

4. The apparatus of claim 3 wherein said plurality of linear sensor arrays is comprised of at least a red linear sensor array, a green linear sensor array, and a blue linear sensor array.

5. The apparatus of claim 1 wherein an optical lens array focuses light from the at least one mirror to the at least one sensor.

6. The apparatus of claim 1 wherein said motor is a stepper motor.

7. The apparatus of claim 1 wherein said motor rotates a cam that engages a yoke to tilt said mirror.

8. The apparatus of claim 7 wherein said motor rotates said cam through a gear train.

9. The apparatus of claim 7 wherein a pawl locks said cam into a plurality of discrete positions.

10. (canceled)

11. A method for dust avoidance in a document scanner comprising:
transporting the document through the scanner;
illuminating the document through a transparent plate;
reflecting light reflected from the document with a mirror;
imaging light from the mirror;
analyzing the image for presence of dust on the transparent plate; and
tilting the mirror if dust is detected.
